(19) United States
(12) Patent Application Publication
(10) Pub. No.: US 2025/0066217 A1
(43) Pub. Date: Feb. 27, 2025

(54) A METHOD FOR PURIFICATION OF MANGANESE PREGNANT LEACH SOLUTION

(71) Applicant: MN ENERGY LIMITED, Victoria Park (AU)

(72) Inventor: Michael John Kitney, South Perth (AU)

(73) Assignee: MN ENERGY LIMITED, Victoria Park, WA (AU)

(21) Appl. No.: 18/721,426

(22) PCT Filed: Jan. 17, 2023
(86) PCT No.: PCT/AU2023/050020

§ 371 Date: Jun. 18, 2024

(30) Foreign Application Priority Data
Jan. 17, 2022 (AU) 2022900076

(51) Int. Cl. C01G 45/10; C22B 3/38; C22B 3/42; C22B 47/00

(52) U.S. Cl. CPC C01G 45/10; C22B 3/38; C22B 3/42; C22B 47/00

(57) ABSTRACT

Provided is a method for purification of manganese pregnant leach solution (PLS) using solvent extraction (SX). The method broadly comprises the steps of providing a partially purified aqueous pregnant leach solution (PLS), using an SX load stage to form a first organic mixture which forms a loaded organic phase comprising all of the manganese from the PLS, performing two stages of SX scrubbing to form a third organic mixture which is substantially free of impurities, performing SX stripping to transfer the manganese content of the scrubbed organic phase into a clean aqueous phase, and producing high purity manganese sulphate monohydrate (HPMSM) crystals from the clean aqueous phase.

### TECHNICAL FIELD

This invention relates broadly to the field of purification of minerals and metals, in general, and more specifically to a method of purification of manganese pregnant leach solution with reference to calcium and magnesium using solvent extraction (‘SX’).

### BACKGROUND ART

The following discussion of the background art is intended to facilitate an understanding of the present invention only. The discussion is not an acknowledgement or admission that any of the material referred to is or was part of the common general knowledge as at the priority date of the application.

Manganese is an important raw material to a multitude of industries, and large portions of the world economy depend on its reliable supply. High purity manganese sulphate monohydrate (HPMSM) is a crystalline salt that has a very low impurity content. Manganese sulphate monohydrate (HPMSM) comprising more than 99.95% Mn and metallic impurities such as calcium, magnesium and base metals not exceeding 5 to 50 ppm in individual cases is often desirable to produce high-quality batteries, such as lithium-ion battery cathodes.

Early methods for the production of HPMSM, incorporated reductive roasting of Mn ores followed by acid leach, limited pregnant leach solution (PLS) purification and electro-winning of Mn. Once produced, Mn metal was redissolved in acid before crystallisation of HPMSM. Whilst electro-winning is tolerant of impurities in feed PLS, such conventional process is generally energy-intensive, primarily in the consumption of carbon-based fuel for roasting and then further in electricity consumption for the production of high-quality Mn metal followed by the use of heat in evaporating water during crystallisation.

Hydrometallurgical approaches to the extraction of Mn from pyrolusite and psilomelane ores using SO₂ reductive leach techniques have been widely evaluated since the mid-20th century, primarily in the United States of America. Having been established as an alternative to roasting, the next goal is to produce PLS of sufficient purity that it may be used as crystalliser feed without passing through the electro-winning step, thus resulting in energy conservation by eliminating the second level of energy use. This approach requires that the PLS be rendered substantially free of impurities by alternative methods to promote the production of HPMSM crystals.

Most Mn ores are represented by cryptomelane, KMn₈O₁₆ (a member of the psilomane group) and pyrolusite, MnO₂ and generally carry iron as the major impurity. Lesser amounts of rock-forming minerals contribute base metals, silica and alkaline metals to the extraction process. Reagents employed to control impurities extracted from the ore introduce their own contaminants to the process.

The process steps involved in conventional pregnant leach solution (PLS) purification include chemical precipitation of potassium and sodium as mixed jarosite, which generally requires the addition of iron as ferric sulphate that has to be controlled by the addition of lime, which introduces calcium and magnesium, or caustic soda, which introduces sodium. Subsequently, traces of base metals including copper, cobalt, nickel and zinc may be controlled by the addition of sodium sulphide or sodium hydrogen sulphide, which again introduces sodium to the PLS.

Finally, calcium and magnesium from both the ore and introduced commercial must lime be removed before crystallisation of HPMSM. Chemical addition such as fluoride and phosphates to precipitate insoluble calcium and magnesium salts, and selective crystallisation of gypsum has been tested. However, none of these approaches has produced a satisfactory result meaning product manganese sulphate monohydrate (MSM) has not met specifications for these elements.

The current invention was conceived with the goal in mind to attempt to propose possible improvements, at least in part, to the known shortcomings in the art of conventional manganese purification practices to produce HPMSM.

### SUMMARY OF THE INVENTION

According to an aspect of the invention there is provided a method for purification of manganese pregnant leach solution (PLS) using solvent extraction (SX), the method comprising the steps of:
providing a partially purified acidic aqueous pregnant leach solution (PLS);
mixing the acidic aqueous PLS with a fixed volume of organic solvent dissolved in an organic diluent and an alkaline solution for Ph control to form a first organic mixture;
allowing the first organic mixture to become quiescent for a predetermined amount of time to form a loaded organic phase comprising manganese from the aqueous PLS and a barren aqueous phase or raffinate comprising calcium and magnesium impurities;
performing SX scrubbing of the loaded organic phase by contacting with a stronger acid solution in water to form a second organic mixture;
allowing the second organic mixture to become quiescent for a predetermined amount of time to form a first scrubbed organic phase which is substantially free of metal impurities and the barren aqueous phase or raffinate comprising calcium and magnesium impurities;
performing SX scrubbing of the first scrubbed organic phase by contacting with a weaker acid solution in water to form a third organic mixture;
allowing the third organic mixture to become quiescent for a predetermined amount of time to form a second scrubbed organic phase which is substantially free of alkaline elements;
performing SX stripping of the second scrubbed organic phase by mixing with an acid solution in water, wherein the SX stripping transfers the manganese content of the second scrubbed organic phase into a clean aqueous phase; and
producing high purity manganese sulphate monohydrate (HPMSM) crystals by evaporative crystallisation of the clean aqueous phase.

In an embodiment, the organic solvent comprises a liquid ion exchange medium dissolved in an organic diluent such as kerosene.

In an embodiment, the organic solvent comprises Di-(2-ethylhexyl)phosphoric acid (DEHPA or HDEHP).

In an embodiment, the organic solvent comprises a phosphinic acid derivative.

Typically, the organic solvent is at concentrations of between 10% to 30% in the organic diluent.

In an embodiment, the alkaline solution comprises any one of caustic soda (NaOH), potassium hydroxide (KOH) or ammonium hydroxide (NH4OH).

In an embodiment, the acid solution comprises sulphuric acid (H₂SO₄).

In an embodiment, the predetermined amount of time is selected from a range of 1 to 20 minutes.

Typically, the step of SX scrubbing of the loaded organic phase facilitates in removal of calcium and magnesium and introduces alkaline elements that are transferred into the loaded organic phase.

Typically, the barren aqueous phase or raffinate is recycled to a manganese leach stage.

Typically, the method includes a step of recycling a mother liquor produced after the production of (HPMSM) crystals to a SX process feed tank.

In an embodiment, the method includes a step of recycling a mother liquor produced after the production of (HPMSM) crystals to an organic scrubbing stage.

In one example, the water includes demineralised and/or deionised water.

According to a further aspect of the invention there is provided a method for purification of manganese pregnant leach solution (PLS) using solvent extraction (SX) substantially as herein described and/or illustrated.

### BRIEF DESCRIPTION OF THE DRAWINGS

The description will be made with reference to the accompanying drawings in which:

FIG. 1A and 1B are diagrammatic flow diagram representations of a solvent extraction process for the purification of manganese pregnant leach solution (PLS), in accordance with an aspect of the invention;

FIG. 2 is a graphical representation that illustrates the loading behaviour of Cyanex 272® as organic solvent in solvent extraction;

FIG. 3 is a graphical representation that illustrates the experimentally determined extraction isotherms for Mn, Ca and Mg into Cyanex 272® as organic solvent at the indicated conditions;

FIG. 4 is a graphical representation that illustrates resulting stripping isotherms for Mn, Ca and Mg under the indicated stripping conditions;

FIG. 5 is a diagrammatic representation of representative method steps of a solvent extraction process for the purification of manganese pregnant leach solution (PLS) in accordance with an aspect of the invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Broadly, the present invention provides for a hydrometallurgical process for the recovery of manganese (Mn) from various naturally occurring Mn ores and the subsequent production of high purity manganese sulphate monohydrate (HPMSM) using solvent extraction (SX). As generally known, SX is a method for concentrating and separating some metals from associated elements. SX generally involves mixing an immiscible organic solvent with an aqueous solution of the metal in question such that the target metal transfers into the solvent, or organic phase. The two phases are then separated and the metal in the organic phase may then be stripped back into a smaller volume of aqueous solution, thus achieving significant concentration uplift while also achieving separation from the remaining elements.

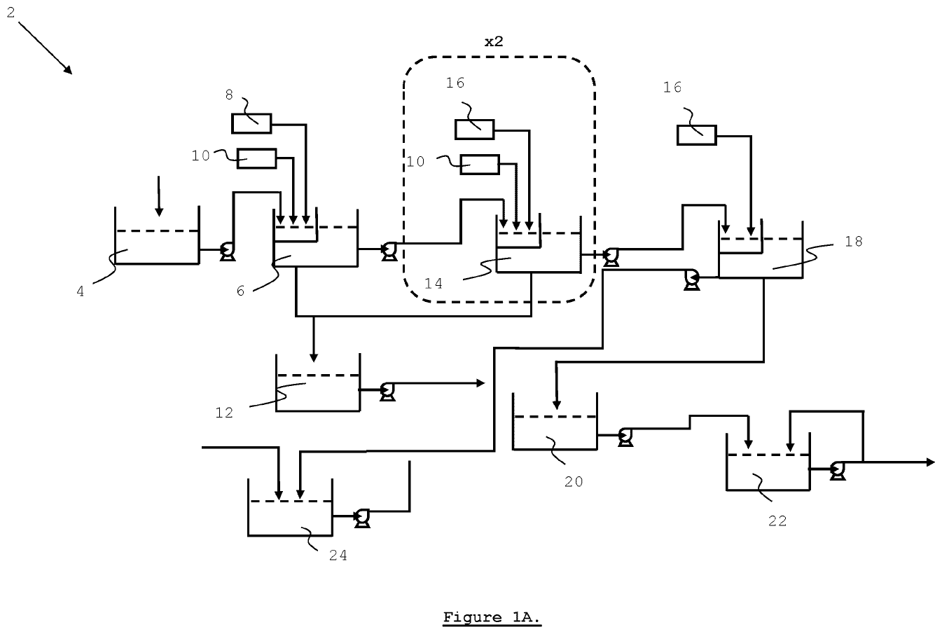

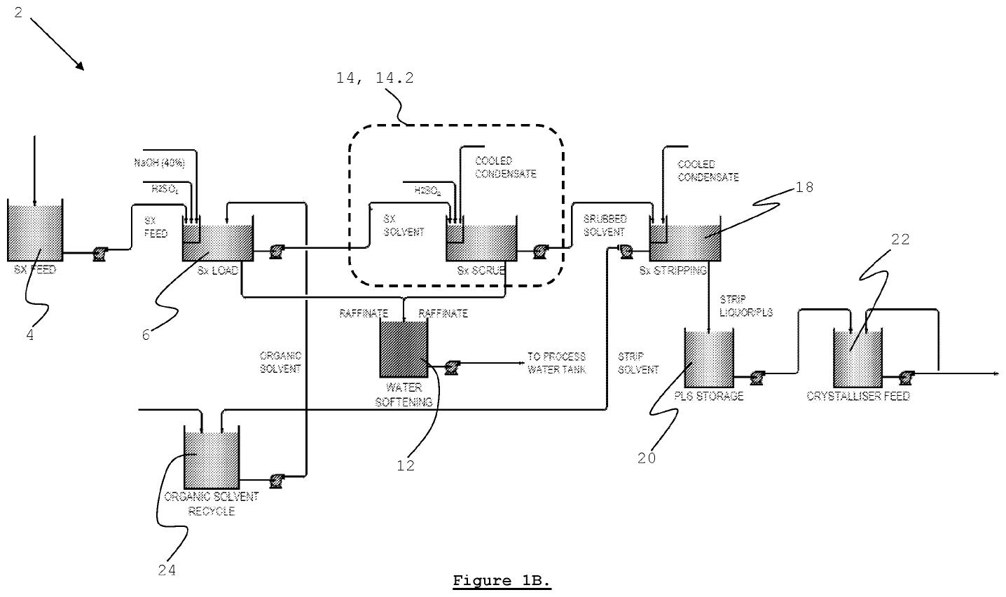

With reference now to FIG. 1 of the accompanying drawings, there is shown an example of a solvent extraction (SX) process for the purification of manganese pregnant leach solution (PLS) in accordance with an aspect of the present invention. A SX feed 4 comprising a partially purified acidic aqueous PLS is obtained. At a SX load stage 6, the aqueous PLS is mixed with a fixed volume of organic solvent 8 dissolved in an organic diluent and a small amount of alkaline solution 10 to form a first organic mixture. In an example, the organic solvent 8 includes caustic soda (NaOH) and the acid solution 10 includes Sulphuric acid (H2SO4), but variations hereon are possible and expected.

At the SX load stage 6, the manganese present in the aqueous PLS is transferred to the organic solvent 8, leaving substantially all of the calcium and magnesium impurities behind. The first organic mixture is allowed to become quiescent for a predetermined amount of time, typically several minutes, during which time a loaded organic phase containing substantially all of the manganese from the PLS separates and is selectively withdrawn from the loading stage. A barren aqueous phase, or raffinate 12, from the SX load stage 6 is recycled to a manganese leach stage of the overall process.

The loaded organic phase progresses to an SX scrub 14 stage where it is contacted with a small amount of acid solution 10 in water 16. In an example, the acid solution 10 includes sulphuric acid (H₂SO₄) and the water 16 includes cooled demin-water. The addition of acid solution 10 at the SX scrub stage 14 facilitates removal of the small quantity of calcium and magnesium that is transferred into the organic phase during the SX load stage 6 to form a second organic mixture. The second organic mixture is allowed to become quiescent over several minutes to form a scrubbed organic phase which is substantially free of all impurities.

In a preferred embodiment, the loaded organic phase progresses to a second SX scrub stage 14.2 where it is contacted with a small amount of dilute acid solution 10 in water at a pH of around 4 again indicated by reference numeral 16. In an example, the acid solution 10 includes sulphuric acid (H2SO4) and the water 16 includes cooled demin-water. The addition of acid solution 10 at such a second SX scrub stage 14 facilitates removal of the alkaline element (either sodium, potassium or ammonium) that is transferred into the organic phase during the SX load stage 6 to form a third organic mixture. The third organic mixture is allowed to become quiescent over several minutes to form a scrubbed organic phase which is substantially free of all impurities.

The aqueous raffinate 12 from the two SX scrub stages 14 is generally recycled to the manganese leach stage of the overall process.

The scrubbed organic phase progresses to an SX strip stage 18 where it is mixed with an appropriate quantity of acid solution 10 in pure water 16. In an example, the acid solution 10 includes sulphuric acid (H₂SO₄) and the water 16 includes cooled demin-water. At the SX strip stage 18, the SX load stage 6 process is reversed such that the manganese content of the organic phase is substantially transferred into a clean aqueous phase 20, typically at a higher concentration than in the original PLS. Following separation of the organic and aqueous phases, the organic stream is directed into a solvent recycle step 24 and further directed into the SX load stage 6 and the clean aqueous phase 20 is delivered to a downstream process for the production of HPMSM crystals 22 and a mother liquor, which is generally recycled to the SX process feed tank.

The skilled addressee is to appreciate that the choice of a particular organic solvent is dependent on both the target metal and the elements associated with the target metal. In some embodiments, Di (2) ethyl-hexyl-phosphoric acid (D2EHPA) and selected phosphonic acid derivatives selective for manganese in the presence of calcium and magnesium. One such phosphonic acid derivative is bis(2,4,4-trimethylpentyl)phosphinic acid marketed by Solvay as Cyanex 272®. Selectivity and loading rates are pH dependent, necessitating selection and control of system pH in the application of SX. When using D2EHPA it is necessary to employ it in two stages as calcium loads at a lower pH than that at which manganese loads and must be removed before elevating pH to load manganese. On the other hand, Cyanex 272® loads manganese at a lower pH than both calcium and magnesium. In the context of purifying Manganese PLS, metals including Fe³⁺, Zn²⁺, Al³⁺ are controlled by precipitation with lime (which adds Ca and Mg), metals including Cu²⁺, Co²⁺, Ni²⁺ are controlled by precipitation with sodium hydrogen sulphide and Ca²⁺, Mg²⁺ are controlled by rejection by solvent extraction. Added sodium, potassium or ammonium are controlled by treatment of raffinate by conventional means.

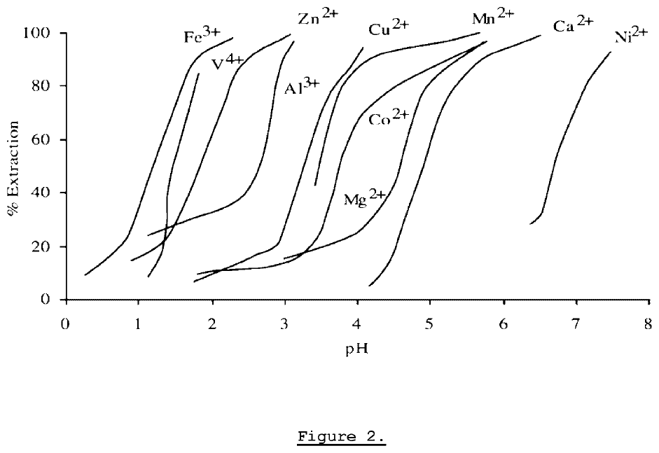

FIG. 2 is a graphical representation that illustrates the loading behaviour of Cyanex 272®. Elimination of the base metal curves: FIG. 2 shows there to be a significant separation of the manganese extraction isotherm from those of calcium and magnesium. As a guide to selectivity, a comparison of the pH value at which 50% extraction of each metal occurs is often of primary interest. Inspection of the above curves shows the pH(50) values to be 3.5, 4.5 and 5 for Mn, Mg and Ca respectively. A difference of 1 pH unit or more indicates selectivity to be adequate for SX to be effective. In this case, the ΔpH(50) value between Mn and Mg is 1 and between Mn and Ca is 1.5, suggesting Cyanex 272® would be an effective reagent.

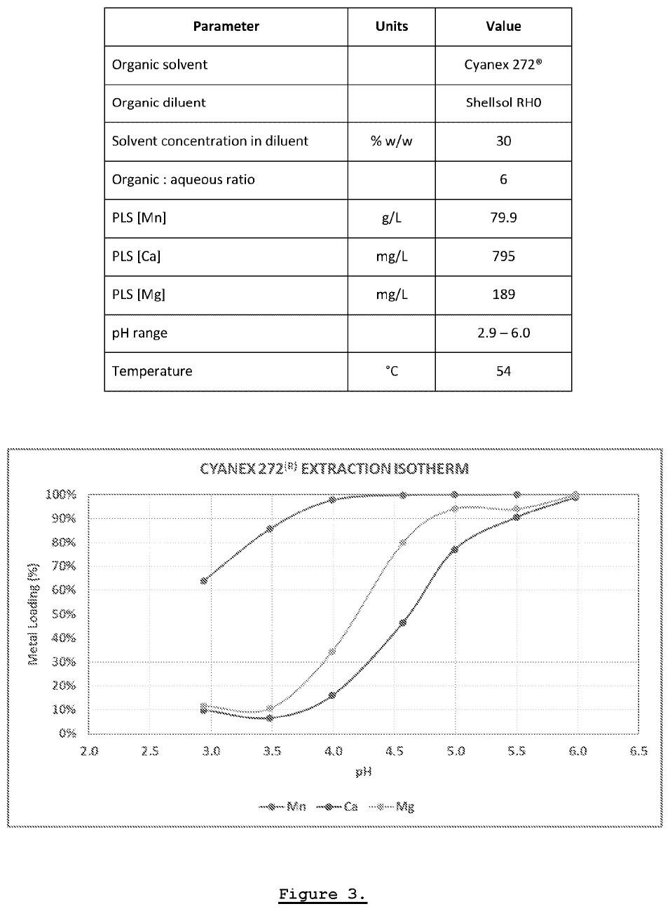

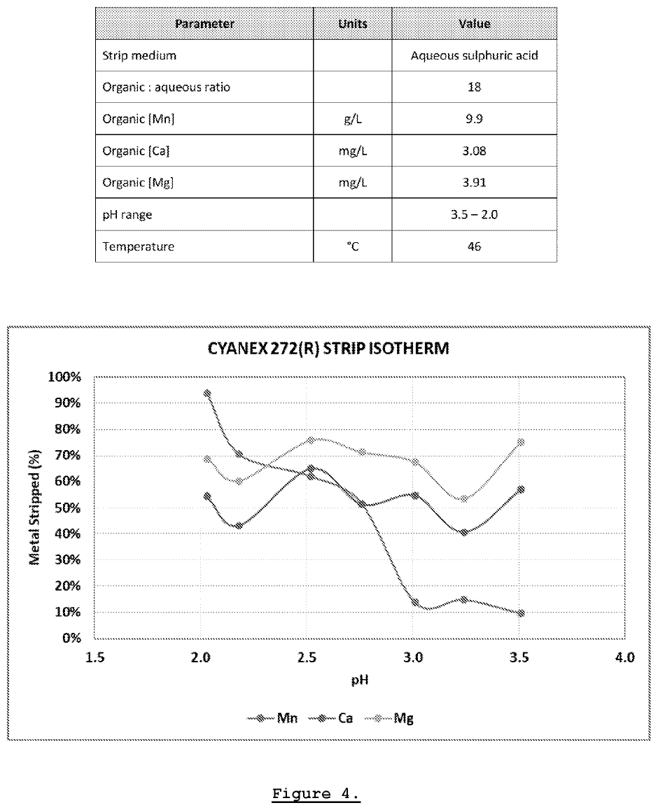

FIG. 3 is a graphical representation that illustrates the experimentally determined extraction isotherms for Mn, Ca and Mg under the indicated conditions. The results indicate that a ΔpH(50) value between Mn and Mg is 1.7 and between Mn and Ca is 2.2, supporting the expected effectiveness of Cyanex 272® as an extractant for manganese.

Figure is a 4 graphical representation that illustrates resulting stripping isotherms for Mn, Ca and Mg using Cyanex 272® as an organic solvent under the indicated conditions. Stripping is the reverse of loading and is thus carried out at a pH value that would normally prevent the loading of the metal into the organic phase. In this case, stripping pH would be expected to be less than 2.5. It was shown that stripping at pH 2 returned 93.8% of the loaded Mn to the aqueous strip phase along with 54.4% of the calcium and 68.7% of the Mg.

In an example embodiment, based on the above approach, a sequential process on a batch of PLS was performed. The following tables describe the results of this sequence of tests:

| | | MNPP-0098 | MNPP-0103 | MNPP-0104 |
|---|---|---|---|---|
| BULK TEST | | Load | Scrub | Strip |
| | | Feed PLS: | Aqueous | SX Product |
| | | | raffinate: | liquor: |
| [Mn] aq | g/L | 79.858 | 30.825 | 93.229 |
| [Ca] aq | mg/L | 795 | 83.1 | 10.3 |
| [Mg] aq | mg/L | 189 | 74.4 | 8.22 |
| [Ca]/[Mn] | mg/g | 9.955 | 2.696 | 0.110 |
| [Mg]/[Mn] | mg/g | 2.367 | 2.414 | 0.088 |
| | | Loaded | Scrubbed | Stripped |
| | | organic: | organic: | organic: |
| [Mn] org | g/L | 9.901 | 7.978 | 0.997 |
| [Ca] org | mg/L | 3.08 | 1.47 | 1.90 |
| [Mg] org | mg/L | 3.91 | 0.56 | 0 |
| [Ca]/[Mn] | mg/g | 0.311 | 0.184 | 1.906 |
| [Mg]/[Mn] | mg/g | 0.395 | 0.070 | 0.000 |
| | | Extraction to | Retained in | Recovery to |
| | | organic: | organic: | aqueous: |
| Mn | % | 85.7 | 85.8 | 86.3 |
| Ca | % | 6.6 | 29.2 | 26.7 |
| Mg | % | 10.6 | 14.9 | 100 |
| System pH | | 3.5 | 3.1 | 2.1 |

Recovery PLS to SX Product Liquor, %

| | |
|---|---|
| Mn | 63.5 |
| Ca | 0.5 |
| Mg | 1.6 |

Concentration SX Product/PLS

| | |
|---|---|
| Mn | 1.17 |
| Ca | 0.01 |
| Mg | 0.04 |

The above data show that significant rejection of calcium and magnesium from high strength manganese sulphate solutions may be achieved by the application of SX. The process improves the overall recovery of manganese from PLS to SX product liquor, thus improving the efficiency of the process.

The following table provides an example final product analysis, crystallised from MNPP-0104 strip liquor, for a typical embodiment:

| Component | Unit | Typical | MNPP-0104 |
|---|---|---|---|
| Mn | % | >31.5 | 31.9 |
| K | ppm | <50 | 1.21 |
| Ca | ppm | <25 | 15 |
| Mg | ppm | <25 | 8 |
| Al | ppm | <10 | 0.15 |
| Fe | ppm | <10 | 0.47 |
| Pb | ppm | <10 | 0.01 |
| Cd | ppm | <5 | 0.002 |
| Cu | ppm | <10 | 0.32 |
| Cr | ppm | Ns* | 1.8 |
| Hg | ppm | ns | 0.002 |
| As | ppm | ns | 0.015 |
| Bi | ppm | ns | 0.01 |
| Sb | ppm | ns | 0.006 |
| Zn | ppm | <10 | 0.236 |
| Ni | ppm | <10 | 3.24 |
| Co | ppm | <10 | 0.184 |
| SiO₂ | ppm | <10 | <1 |

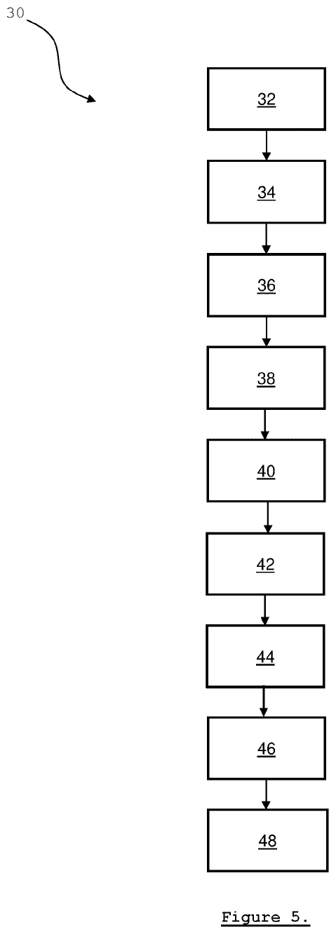

Referring now to FIG. 5 of the accompanying drawings, there is shown a flow diagram with blocks or steps representative of a method 30 for a solvent extraction process for the purification of manganese pregnant leach solution (PLS) in accordance with an aspect of the invention. The method 30 generally comprises the steps of obtaining or providing 32 a partially purified acidic aqueous pregnant leach solution 4 as described herein, mixing 34 the aqueous PLS with a fixed volume of organic solvent 8 dissolved in an organic diluent and a small amount of acid alkaline solution 10 to form a first organic mixture, allowing 36 the first organic mixture to become quiescent over several minutes to form a loaded organic phase comprising all of the manganese from the PLS and a barren aqueous phase or raffinate 12 comprising calcium and magnesium impurities.

Method 30 then includes the steps of performing 38 SX scrubbing of the loaded organic phase by contacting with a small amount of acid solution 10 in water 16 to form a second organic mixture, allowing 40 the second organic mixture to become quiescent to form a scrubbed organic phase which is substantially free of calcium and magnesium impurities all impurities and the barren aqueous phase or raffinate 12 comprising calcium and magnesium impurities, performing 42 a second scrubbing step employing a weak acid solution to form a third organic phase, allowing 44 the third organic mixture to become quiescent to form a scrubbed organic phase which is substantially free of added alkaline elements, SX stripping 46 of the scrubbed organic phase by mixing with an appropriate quantity of acid solution 10 in pure water 16 to transfer the manganese content of the scrubbed organic phase into a clean aqueous phase 20, and producing 48 high purity manganese sulphate monohydrate (HPMSM) crystals from the clean aqueous phase 20.

Accordingly, the method 30 described herein broadly comprises that partially purified PLS is delivered to the SX load stage where it is mixed with a fixed volume of organic solvent, which itself is dissolved in an organic diluent. Upon contact between the two phases, the manganese in the aqueous PLS transfers to the organic solvent, leaving substantially all of the calcium and magnesium impurities behind. The organic/aqueous mixture is then allowed to become quiescent for a predetermined amount of time, typically several minutes, during which time the loaded organic containing substantially all of the manganese from the PLS separates and is selectively withdrawn from the loading stage. The now barren aqueous phase, or raffinate, is recycled to the manganese leach stage of the overall process.

After this, the loaded organic phase progresses to the two SX scrub stages 14, 14.2 where it is respectively contacted with small amounts of acid solution in water. This contact facilitates the small removal of quantity of calcium and magnesium that transfers into the organic phase during the SX load step. Again, the mixture is allowed to become quiescent and the aqueous raffinate from this step is recycled to the manganese leach stage of the overall process.

Following this, the scrubbed organic phase, which is now substantially free of all impurities, progresses to the SX strip stage where it is mixed with an appropriate quantity of stronger acid solution in pure water. This step reverses the SX load process such that the manganese content of the organic phase is substantially transferred a clean aqueous phase, typically at a higher concentration than in the original PLS. Following separation of the organic and aqueous phases, the organic stream is returned to the SX load step and the loaded aqueous stream is delivered to the downstream process for the production of HPMSM crystals and a mother liquor, which is recycled to the SX process feed tank.

Applicant believes it advantageous that the present invention broadly provides for an improved hydrometallurgical process for the recovery of manganese and the subsequent production of high purity manganese sulphate monohydrate (HPMSM). Such HPMSM may be in excess of 99.95% Mn and metallic impurities, such as calcium, magnesium, and base metals and alkaline elements, not exceeding 5 to 50 ppm.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known techniques and technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A method for purification of manganese pregnant leach solution (PLS) using solvent extraction (SX), the method comprising the steps of:
providing a partially purified acidic aqueous pregnant leach solution (PLS);
mixing the acidic aqueous PLS with a fixed volume of organic solvent dissolved in an organic diluent and an alkaline solution for Ph control to form a first organic mixture;
allowing the first organic mixture to become quiescent for a predetermined amount of time to form a loaded organic phase comprising manganese from the aqueous PLS and a barren aqueous phase or raffinate comprising calcium and magnesium impurities;
performing SX scrubbing of the loaded organic phase by contacting with a stronger acid solution in water to form a second organic mixture;
allowing the second organic mixture to become quiescent for a predetermined amount of time to form a first scrubbed organic phase which is substantially free of metal impurities and the barren aqueous phase or raffinate comprising calcium and magnesium impurities;
performing SX scrubbing of the first scrubbed organic phase by contacting with a weaker acid solution in water to form a third organic mixture;
allowing the third organic mixture to become quiescent for a predetermined amount of time to form a second scrubbed organic phase which is substantially free of alkaline elements;
performing SX stripping of the second scrubbed organic phase by mixing with an acid solution in water, wherein the SX stripping transfers the manganese content of the second scrubbed organic phase into a clean aqueous phase; and
producing high purity manganese sulphate monohydrate (HPMSM) crystals by evaporative crystallisation of the clean aqueous phase.

2. The method of claim 1, wherein the organic solvent comprises a liquid ion exchange medium dissolved in an organic diluent such as kerosene.

3. The method of claim 1, wherein the organic solvent comprises Di-(2-ethylhexyl)phosphoric acid (DEHPA or HDEHP).

4. The method of claim 1, wherein the organic solvent comprises a phosphinic acid derivative.

5. The method of claim 1, wherein the organic solvent is at concentrations of between 10% to 30% in the organic diluent.

6. The method of claim 1, wherein the alkaline solution comprises any one of caustic soda (NaOH), potassium hydroxide (KOH) or ammonium hydroxide (NH4OH).

7. The method of claim 1, wherein the acid solution comprises sulphuric acid (H2SO4).

8. The method of claim 1, wherein the predetermined amount of time is selected from a range of 1 to 20 minutes.

9. The method of claim 1, wherein the step of SX scrubbing of the loaded organic phase facilitates in removal of calcium and magnesium and introduces alkaline elements that are transferred into the loaded organic phase.

10. The method of claim 1, wherein the barren aqueous phase or raffinate is recycled to a manganese leach stage.

11. The method of claim 1, further comprising a step of recycling a mother liquor produced after the production of (HPMSM) crystals to a SX process feed tank.

12. The method of claim 1, further comprising a step of recycling a mother liquor produced after the production of (HPMSM) crystals to an organic scrubbing stage.

13. The method of claim 1, wherein the water includes demineralised and/or deionised water.
